(19) United States
(12) Patent Application Publication
(10) Pub. No.: US 2026/0141666 A1
(43) Pub. Date: May 21, 2026

(54) ACTIVE LEARNING FOR DETECTION LABELING VIA FOUNDATION MODELS

(71) Applicant: Walmart Apollo, LLC, Bentonville, AR (US)

(72) Inventors: Feiyun Zhu, Plano, TX (US); Wei Wang, Dallas, TX (US); Lingfeng Zhang, Flower Mound, TX (US); Mingquan Yuan, Flower Mound, TX (US); Zhaoliang Duan, Frisco, TX (US); Yilun Chen, McKinney, TX (US); Colin Grant Mitchell, Wills Point, TX (US); William Craig Robinson, Centerton, AR (US)

(21) Appl. No.: 19/178,716

(22) Filed: Apr. 14, 2025

Related U.S. Application Data
(60) Provisional application No. 63/634,579, filed on Apr. 16, 2024.

(51) Int. Cl. G06V 10/25; G06T 7/12; G06V 10/774; G06V 20/70

(52) U.S. Cl. CPC G06V 10/25; G06T 7/12; G06V 10/7753; G06V 20/70; G06T 2207/20132; G06V 2201/07

(57) ABSTRACT

Examples provide active learning for effective computer vision (CV) item detection labeling using foundation models to generate updated training data for retraining CV item detection models. Raw image data of shopping carts in a retail facility are analyzed by a pretrained CV item detection model to identify items in the carts. The detected items are labeled and enclosed in bounding boxes. A set of foundation models mask the detected items in the cart images. Predicted labels for the undetected and unmasked items in the cart images are generated. Predicted bounding boxes enclosing the unmasked items undetected by the CV item detection model are generated. The predicted bounding boxes and predicted labels are merged with the detected items bounding boxes and labels to generate updated training data for dynamically retaining the CV item detection model to detect future occurrences of the undetected items in cart images with greater accuracy and efficiency.

### BACKGROUND

In order to maintain the precision of deep learning computer vision (CV) object detection and recognition models over time, it is typically necessary to periodically retrain the models using new labeled training images incorporated into training data used to retrain the models. The new labeled training images are generated via a time-consuming manual process of identifying useful images from a pool of unlabeled data and manually labeling these images. In addition to the arduous task of sorting and labeling potentially thousands of raw images, the process is further complicated by the difficulty in identifying and selecting the most valuable data from the unlabeled pool. This process is slow, tedious, time-consuming, inefficient, and potentially cost prohibitive due to the expenditure of time and resources involved in data annotation.

### SUMMARY

Some examples provide a system and method for identifying missed item detections by computer vision (CV) item detection models using foundation models. A first set of one or more items in a cart image are detected by a computer vision (CV) item detection model. Each item in the set of detected items is associated with a bounding box in a first set of bounding boxes. The first set of items detected by the CV item detection model are masked by a first foundation model. A second foundation model identifies a second set of one or more items in the cart image which are undetected by the CV item detection model. The undetected items are unmasked in the cart image. A label identifying the undetected item is added to each item in the second set of items. A third foundation model generates a predicted bounding box for each undetected item in the second set of items. A set of predicted bounding boxes corresponds to the second set of items and is merged with the first set of bounding boxes corresponding to the first set of items detected by the CV item detection model. The merged set of items, including the second set of items undetected by the CV detection model with the predicted labels and predicted bounding boxes are used to update training data used to retrain the CV detection model to recognize the second set of items.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for identifying missing items in image data remaining undetected by a CV item detection model.

FIG. 2 is an exemplary block diagram illustrating a retail facility including image capture devices and checkout terminals for generating receipts and cart images.

FIG. 3 is an exemplary block diagram illustrating an undetected item manager for identifying missing item detections in image data.

FIG. 4 is an exemplary block diagram illustrating an undetected item manager including a set of foundation models for identifying missing item detections.

FIG. 5 is an exemplary image of a shopping cart including a plurality of items within the shopping cart.

FIG. 6 is an exemplary image of a shopping cart including a set of masked items.

FIG. 7 is an exemplary image of an undetected item identified within a cart image using a set of foundation models.

FIG. 8 is an exemplary image of a shopping cart including a plurality of items for analysis by a pretrained computer vision (CV) item detection model.

FIG. 9 is an exemplary image of a shopping cart including a set of bounding boxes enclosing a set of items detected by a pretrained CV item detection model.

FIG. 10 is an exemplary image of a shopping cart including a set of masked items.

FIG. 11 is an exemplary image of a shopping cart including a set of predicted bounding boxes corresponding to a set of items undetected by the pretrained CV item detection model.

FIG. 12 is an exemplary flow chart illustrating operation of the computing device to identify missing item detections by a CV item detection model.

FIG. 13 is an exemplary flow chart illustrating operation of the computing device to analyze image data using a set of foundation models to identify missing item detections.

FIG. 14 is an exemplary flow chart illustrating operation of the computing device to update training data for use in retraining CV item detection models to detect previously undetected items.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Computer vision (CV) object detection models, such as image recognition as a service (IRAS) models, are used for automated item detection and item identification. These models are trained using manually labeled training data. The training data consists of images with labeled objects in the images. Human users label the images manually to create the training data.

In order to maintain the precision of deep learning models over time, it is frequently necessary to persistently annotate fresh data and incorporate it into the training dataset for periodic model retraining. A significant hurdle in this process is selecting the most valuable data from the unlabeled image data pool, in order to not only boost a deep learning model's performance during training but also to manage the expenditure of time and resources involved in labeling the image data for use during training. Moreover, the models may fail to detect some items due to changes in item layout, item assortment, packaging, rarity of the items in cart images, etc. Therefore, the models require retraining and/or updating to ensure the models can detect all items.

For object detection, it is important to generate training images for items where the trained CV model failed to identify the item of interest (target object), which is needed to retrain the CV model to identify the item of interest in future. These target object detection failures can occur due to appearances of uncommon (rare) items in an image, the placement of items in a shopping cart, variations in camera setup, differing store environments, introduction of new items, and/or changes or other alterations to previously identifiable items, such as new item packaging. Such detection failures make subsequent tasks more challenging in item recognition, potentially leading to incorrect decisions and negatively impacting customer experience.

Referring to the figures, examples of the disclosure enable use of large pre-trained models, such as a segment anything model (SAM), to automate the filtering process, efficiently pinpointing unlabeled image data that is likely to be the most advantageous for use during the retraining phase of computer vision (CV) deep learning models, such as object detection and/or object recognition models.

In some examples, the embodiments provide a set of one or more foundation models for identifying items in a cart image which go undetected by a CV item detection model used to retain the CV item detection model to identify items appearing more accurately in images of shopping carts.

Aspects of the disclosure further enable application of foundation models to mask detected items in image data enabling identification of unmasked and undetected items in the images automatically and with improved accuracy. This enables reduced system resource usage consumed during manual labeling of item images and manual correction of incorrectly labeled item images.

The conventional computing device operates in an unconventional manner by automatically identifying and labeling undetected items in cart images while reducing usage of processor and memory resources. The system generates predicted bounding boxes and predicted labels for the undetected items which are used to more accurately and effectively train CV item detection models to identify a broader range of items and varieties of items in a retail facility while reducing network bandwidth usage consumed during manual labeling and manual correction/review of incorrectly labeled image data. In this manner, the computing device is used in an unconventional way, and allows improved efficiency while reducing usage of processor, memory, and network resources, thereby improving the functioning of the underlying device.

In other embodiments, the system leverages one or more foundation models to find valuable image data for model retraining instead of relying on human labelers to sort through large pools of unlabeled data to identify useful images. The system provides an auto-training pipeline for item (object) detection models by incorporating a set of foundation models into the pipeline. The item detection models are trained with a vast amount of machine-labeled data which performs better than a model trained using a smaller amount of human-labeled data. The system further improves the speed with which training data used to retrain the CV item detection models is produced while also reducing the error rate associated with automatically labeled image data used to train CV item detection and item recognition models.

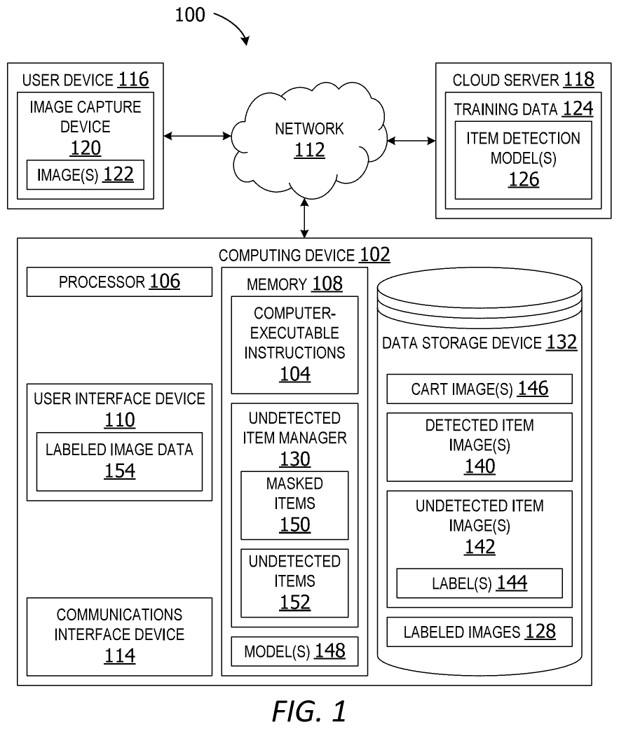

Referring again to FIG. 1, an exemplary block diagram illustrates a system 100 for identifying missing items in image data remaining undetected by a CV item detection model. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

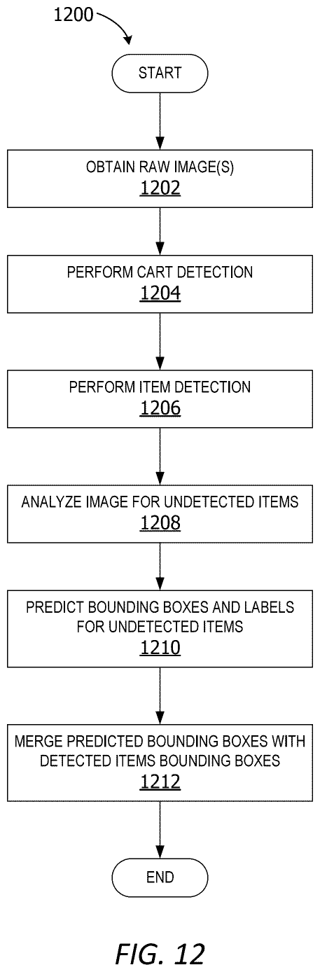

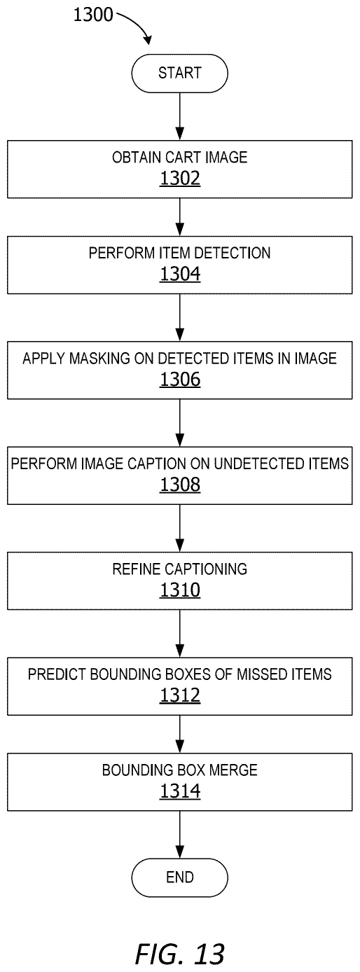

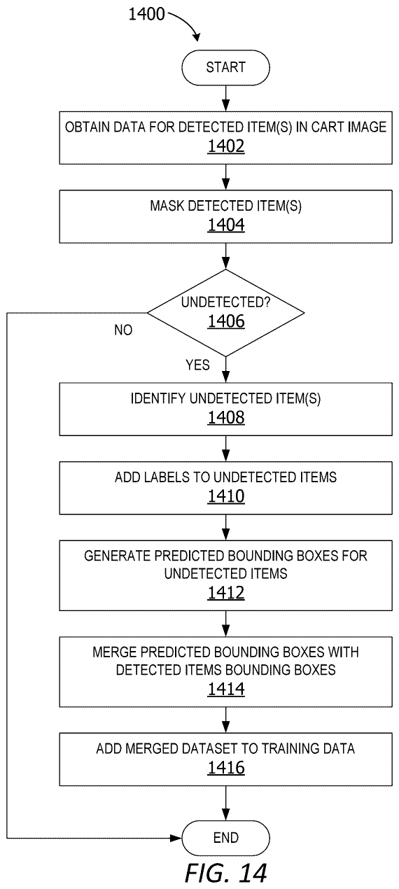

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 12, FIG. 13, and/or FIG. 14).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown).

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to user device 116 and/or cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device. In this example, the user device 116 includes an image capture device 120 for generating one or more image(s) 122 of one or more shopping carts.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The cloud server 118 optionally includes a cloud storage for storing data, such as, but not limited to, training data 124 used to train or retrain one or more CV item detection model(s) 126. The CV item detection model(s) 126 include one or more CV deep learning models for detecting objects of interest in image(s) 122. The item detection model(s) 126 are initially trained, in some embodiments, using manually labeled images. The system 100 generates automatically labeled images 128 for retraining or fine-tuning the item detection model(s) 126.

The system 100 can optionally include a data storage device 132 for storing data, such as, but not limited to cart image(s) 146 obtained from one or more of the image(s) 122, detected item image(s) 140 obtained from the cart image(s) 146, undetected item image(s) 142 obtained from the cart image(s) 146, and/or labeled images 128 generated by the undetected item manager 130 for use in updating the training data 124. The undetected item image(s) 142, in some embodiments, includes cropped item images of one or more items undetected by the item detection model(s) 126. The undetected item manager 130 adds one or more predicted label(s) 144 to the undetected item image(s) 142 and/or to the cart image(s) 146 for use in retraining the item detection model(s) 126. The label(s) 144 may be referred to as annotations or captions identifying the undetected items. The label(s) 144 in this example include a text name or description of each undetected item in the undetected item image(s) 142. The label(s) 144 are automatically generated labels which are produced by the undetected item manager 130 without manual labeling by a human or any other human intervention within the labeling pipeline. In some embodiments, the text labels are added to identify undetected items in images.

The data storage device 132 can include one or more different types of data storage devices, such as, for example, one or more rotating disks drives, one or more solid state drives (SSDs), and/or any other type of data storage device. The data storage device 132 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 132 includes a database.

The data storage device 132 in this example is included within the computing device 102, attached to the computing device, plugged into the computing device, or otherwise associated with the computing device 102. In other examples, the data storage device 132 includes a remote data storage accessed by the computing device via the network 112, such as a remote data storage device, a data storage in a remote data center, or a cloud storage.

The memory 108 in some examples stores one or more computer-executable components, such as, but not limited to, the undetected item manager 130. The undetected item manager 130 is a software component that, when executed by the processor 106 of the computing device 102, analyze image(s) 122 and detected item data associated with the detected item image(s) 140 generated by the CV item detection model(s) 126. The item detection model(s) 126 detect one or more items in a cart image generated by an image capture device associated with a retail facility, such as, but not limited to, the image capture device 120. The item detection model(s) generate a set of bounding boxes identifying the location or coordinates of each detected item in the cart image(s) 146.

The image capture device 120 is any type of device for generating digital images of shopping carts and other items of interest. However, the embodiments are not limited to an image capture device implemented within a user device 116. In other embodiments, the image capture device 120 is mounted to a fixture, mounted to a robotic device, and/or a hand-held image capture device for generating image(s) 122.

The undetected item manager 130 utilizes one or more machine learning (ML) model(s) 148 to mask each detected item in the cart image(s) 146. The model(s) 148 include any type of ML model, such as, but not limited to, a generative language model, transformer model, deep learning model, convolutional neural network model (CNN), or any other type of model for masking detected items based on bounding box coordinates associated with each detected item.

The undetected item manager 130 identifies one or more undetected items 152 which are not included in the set of one or more masked items 150 masked by the undetected item manager 130. The undetected items 152 are identified and labeled to form the labeled images 128. The undetected item manager 130 generates a set of predicted bounding boxes associated with each undetected item in the set of undetected items for each cart image. The predicted bounding boxes for the undetected items are merged with the bounding boxes generated by the item detection model(s) for the detected items to create a merged dataset. The labeled image data 154, including the labeled images 128, are added to the training data 124 and used to retrain or further refine the item detection model(s) 126.

In these embodiments, the image(s) 122 and/or cart image(s) 146 do not include images of users or other individuals within the retail facility. Any images having human users or other objects which are not of interest inadvertently included within the images are removed from the image(s) 122 and/or the cart image(s) 146 by cropping the images such that only objects of interest remain in the cropped images. Images of users or objects which are not of interest are deleted or otherwise discarded. The cropped images containing only the objects of interest are then analyzed to identify and label the objects of interest within the cropped images, such as, but not limited to, the image(s) 122 and/or the cart image(s) 146.

In this example, the item detection model(s) 126 are implemented on the cloud server 118. However, in other embodiments, one or more of the item detection model(s) are implemented on the computing device 102 and/or the user device 116.

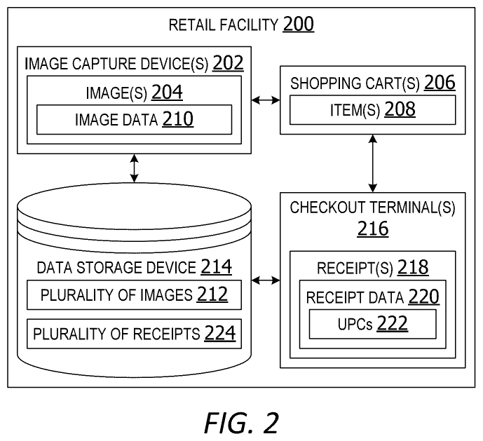

FIG. 2 is an exemplary block diagram illustrating a retail facility 200 including image capture devices and checkout terminals for generating receipts and cart images. The retail facility 200 is any type of brick-and-mortar facility, such as a retail store. One or more image capture device(s) 202 generating one or more image(s) 204 of one or more shopping cart(s) 206 containing one or more item(s) 208 being purchased or already purchased by one or more customers. The image capture device(s) 202, in some examples, include one or more digital cameras capturing digital images of the shopping cart(s) 206. The digital image(s) include image data 210. In this example, the image capture device(s) 202 include three cameras at or near the checkout terminal. However, the embodiments are not limited to three cameras. In other examples, the image capture device(s) 202 include a single camera, two cameras, as well as four or more cameras. In some embodiments, the image capture devices are removably attached to an arch or other support structure. In still other examples, one or more image capture devices are mounted to a portion of the ceiling, wall, support pillar or other structure within the retail facility.

The plurality of images 212 generated by the image capture device(s) 202 are optionally stored on a data storage device 214. The plurality of images 212 include cart images, such as, but not limited to, the cart image(s) 146 in FIG. 1. The data storage device 214 is a device for storing data, such as, but not limited to, the data storage device 132 in FIG. 1. In other examples, the plurality of images 212 are stored on a cloud storage, such as, but not limited to, the cloud server 118 in FIG. 1.

One or more checkout terminal(s) 216 generate one or more receipt(s) 218 including receipt data 220 associated with the purchase of one or more item(s) 208 purchased by customers. The checkout terminal(s) 216 include any type of checkout terminal, such as, but not limited to, a staffed POS device, a self-checkout device, a Scan-N-Go (SNG) device, or any other type of checkout device. The checkout terminal(s) 216 enable a user to complete a purchase transaction for one or more items and receive a receipt documenting the purchase transaction. The receipt data includes information, such as, but not limited to, a store ID, a checkout terminal ID, a time of purchase, date of purchase, item ID for each item purchased, number of items purchased, name of items purchased, description of items purchased, and/or type of payment provided to complete the purchase.

In some embodiments, the receipt data includes a universal product code (UPC) or other item ID for each item purchased. In this example, the one or more receipt(s) 218 include UPCs 222 associated with items purchased in one or more transactions. The plurality of receipts 224 and/or the plurality of images 212 generated within a given time period are stored as historical data on the data storage device 214 located in the retail facility. In other embodiments, the plurality of receipts 224 and/or the plurality of images 212 are stored on a cloud storage or other remote data storage device which is accessed via a network, such as, but not limited to, the network 112 in FIG. 1.

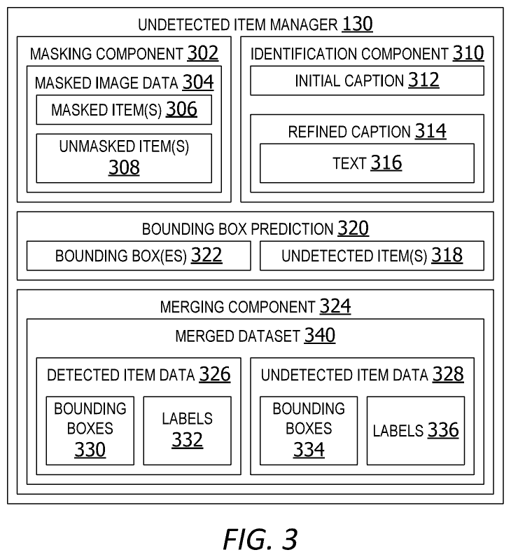

FIG. 3 is an exemplary block diagram illustrating an undetected item manager 130 for identifying missing item detections in image data. In some embodiments, a masking component 302 generates masked image data 304 by masking a first set of items associated with a cart image detected by a CV item detection model. The cart image is generated by an image capture device associated with a retail facility, such as, but not limited to, the image capture device 120 in FIG. 1 and/or the image capture device(s) 202 in FIG. 2. Each item in the set of one or more masked item(s) 306 is associated with a bounding box generated by the item detection model. A set of one or more unmasked item(s) 308 includes items remaining undetected by the item detection model. The unmasked item(s) 308 are not associated with bounding boxes or bounding box coordinates generated by the item detection model because the pretrained item detection model failed to detect the unmasked item(s) 308 in the image data generated by the image capture device(s). In other words, detected items are enclosed by bounding boxes. The detected items are masked. The undetected items remain unenclosed by any bounding boxes. These undetected items are unmasked. The system optionally locates undetected items in the masked image data by performing image segmentation.

An identification component 310 identifies undetected item(s) 318 and generates an initial caption 312 identifying each item. The initial caption includes one or more names or descriptors for each undetected item. The identification component optionally provides a more refined caption 314 identifying each undetected item in text 316 with greater accuracy than the initial caption 312. The refined caption 314 provides a more accurate label or annotation identifying the undetected item.

A bounding box prediction 320 generates one or more predicted bounding box(es) 322 for each of the items in the set of one or more undetected item(s) 318. The predicted bounding box includes a set of coordinates associated with the location of each undetected item in a cart image.

A merging component 324 merges detected item data 326 with undetected item data 328 into a merged dataset 340. The detected item data 326 includes bounding boxes 330 and labels 332 provided by one or more item detection model(s). The undetected item data 328 includes one or more predicted bounding boxes 334 and/or one or more predicted labels 336 for the undetected item(s) 318 identified by the undetected item manager 130. The merged dataset 340, in some embodiments, is added to training data and/or updated training data for re-training CV item detection model(s). The training data is updated periodically using the merged datasets. The training data is continuously retrained, in some embodiments, to continuously improve detection of items appearing in images.

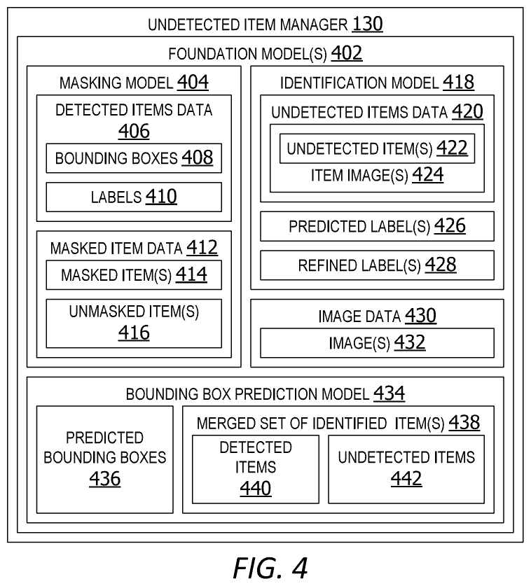

Turning now to FIG. 4, an exemplary block diagram illustrating an undetected item manager 130 including a set of one or more foundation model(s) 402 for identifying missing item detections is shown. Active learning is a machine learning strategy that prioritizes the selection of the most informative samples for labeling to improve model performance. A foundation model is a type of machine learning model that can be adapted to many applications. Foundation models are trained on large amounts of unlabeled data in a pool of unlabeled image data. They are known for their adaptability and slow processing times.

A masking model 404, in this example, is a foundation model that obtains detected items data 406 from one or more item detection models, such as, but not limited to, the item detection model(s) 126 in FIG. 1. The detected items data 406 includes bounding boxes 408 associated with each detected object of interest and/or labels 410 identifying each detected item.

The masking model generates masked item data 412, including one or more masked item(s) 414 and/or one or more unmasked item(s) 416. The masked item(s) 414 include detected items which are masked by the masking model. The masked item(s) are associated with a bounding box generated by the item detection models. The unmasked item(s) 416 include undetected items. The undetected items are not associated with a bounding box. The undetected items are not masked in the image data by the masking model 404.

In some embodiments, an identification model 418 is a second foundation model in the set of foundation model(s) 402. The identification model 418 identifies one or more undetected item(s) 422 in one or more image(s) 432 of the image data 430. In this example, the image(s) 432 include one or more cart images cropped from a raw image.

Undetected items data 420 includes data associated with one or more undetected (unmasked) items in a cart image. In some examples, the undetected item(s) 422 are at least partially visible in one or more item image(s) 424. The identification model generates one or more predicted label(s) 426. In some embodiments, the identification model generates refined label(s) 428. The refined label(s) include more accurate name or description of the items, such as, but not limited to, the refined caption 314.

A bounding box prediction model 434 is a third foundation model in the set of foundation model(s) 402. The bounding box prediction model generates predicted bounding boxes 436 associated with the location of each undetected item in the undetected items data 420. The predicted bounding boxes 436 are merged with the bounding boxes 408 generated by the CV item detection model(s) to form a merged set of identified item(s) 438. The merged set of identified items includes the detected items 440 and the undetected items 442.

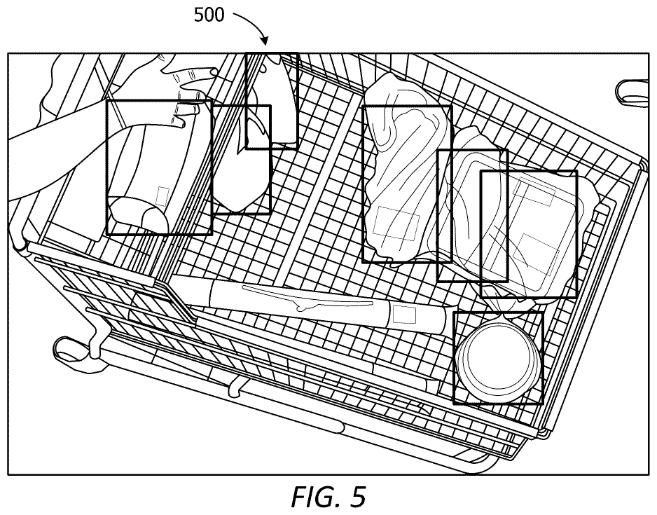

FIG. 5 is an exemplary image 500 of a shopping cart including a plurality of items within the shopping cart. In this example, based on current object detection model results, the undetected item manager gets a bounding box of each detected item in a given cart image.

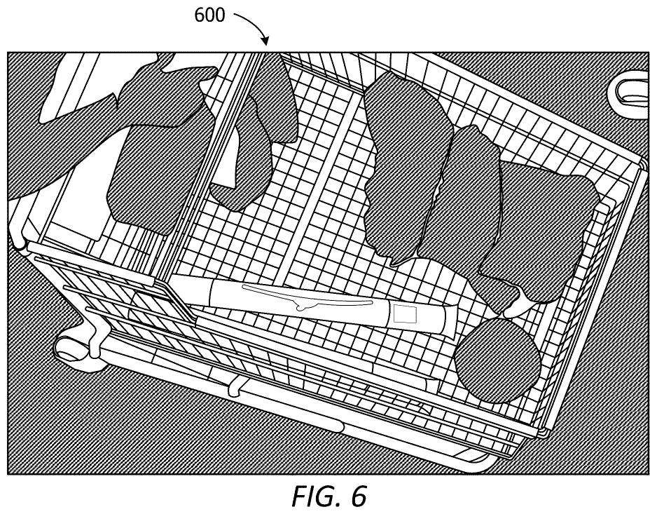

Referring now to FIG. 6, an exemplary image 600 of a shopping cart including a set of masked items is shown. The undetected item manager blacks out the detected items in the cart image. In this example, the system blacks out other objects as welk, such as, but not limited to, the floor and/or any images of a human or portion of a human appearing in the image based on pre-trained segmentation model (SAM).

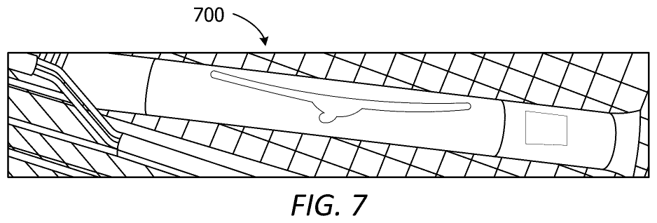

FIG. 7 is an exemplary image 700 of an undetected item identified within a cart image using a set of foundation models. In this example, the undetected item manager segments the image by applying a segmentation model, such as, but not limited to, a SAM model. A graphics algorithms is optionally applied to find the undetected items in the cart image.

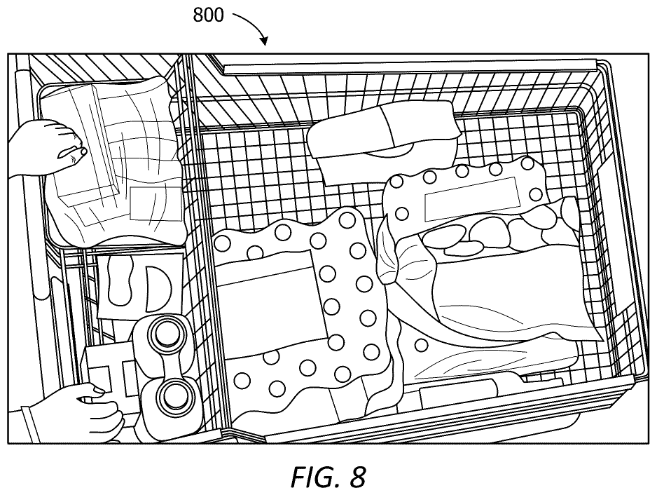

FIG. 8 is an exemplary image 800 of a shopping cart including a plurality of items for analysis by a pretrained computer vision (CV) item detection model. The system generates captions for the objects in the image, such as, but not limited to, a bottle, a human hand, eggs, hot dogs, etc. The refined labels (captions) include labels such as bottles and/or eggs.

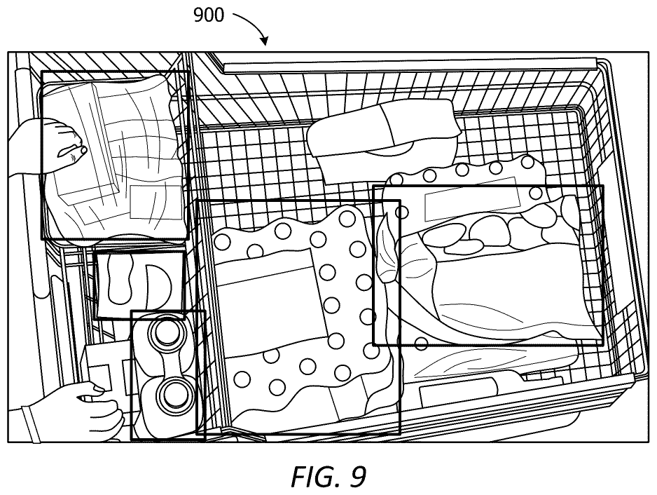

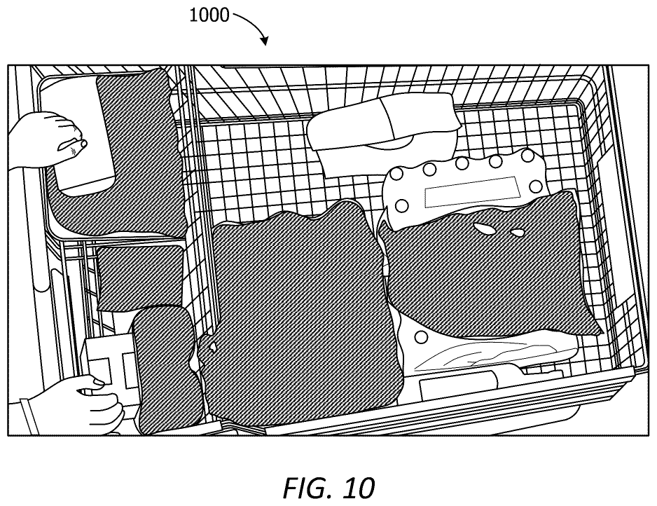

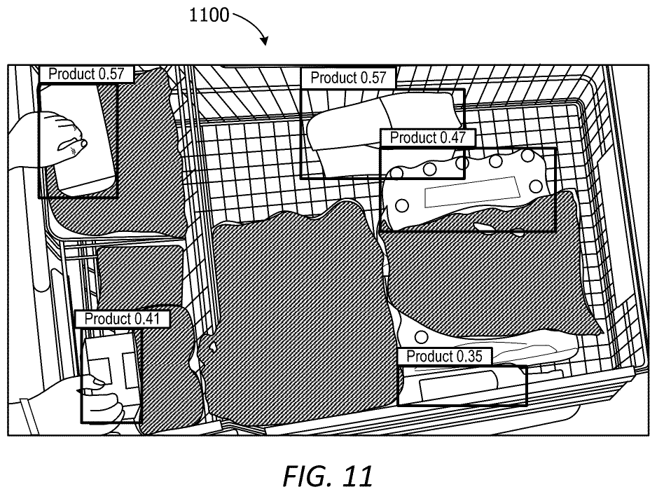

FIG. 9 is an exemplary image 900 of a shopping cart including a set of bounding boxes enclosing a set of items detected by a pretrained CV item detection model. FIG. 10 is an exemplary image 1000 of a shopping cart including a set of masked items. FIG. 11 is an exemplary image 1100 of a shopping cart including a set of predicted bounding boxes corresponding to a set of items undetected by the pretrained CV item detection model.

FIG. 12 is an exemplary flow chart illustrating operation of the computing device to identify missing item detections by a CV item detection model. The process 1200 shown in FIG. 10 is performed by a customized returns manager component, executing on a computing device, such as the computing device 102 or the user device 116 in FIG. 1.

The process begins by obtaining raw image(s) at 1202. The image(s) are obtained from one or more image capture devices, such as, but not limited to, the image capture device(s) 202 in FIG. 2. Cart detection is performed at 1204. The cart detection, in some embodiments, is performed by a pretrained CV cart detection model. Item detection is performed at 1206. The item detection, in some embodiments, is performed by a pretrained item detection model, such as, but not limited to, the item detection model(s) 126 in FIG. 1. The image is analyzed for undetected items at 1208. The undetected item manager predicts bounding boxes and labels for the undetected items at 1210. The predicted bounding boxes are merged with detected item bounding boxes at 1212. The process terminates thereafter.

While the operations illustrated in FIG. 12 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 12.

FIG. 13 is an exemplary flow chart illustrating operation of the computing device to analyze image data using a set of foundation models to identify missing item detections. The process 1300 shown in FIG. 13 is performed by a customized returns manager component, executing on a computing device, such as the computing device 102 or the user device 116 in FIG. 1.

The process begins by obtaining a cart image at 1302. The cart image is an image containing at least a portion of a shopping cart and one or more items in the shopping cart, such as, but not limited to, the cart image(s) 146. The process performs item detection at 1304. The item detection is performed by a trained CV item detection model, such as, but not limited to, the item detection model(s) 126. Masking is applied on the detected items in the image at 1306. Image caption is performed at 1308. The image cations on the undetected items creates labels (captions) identifying the items in the images. The captioning is refined at 1310. Bounding boxes are predicted for the missed items at 1312. The bounding boxes are merged at 1314. The bounding boxes for the detected items and the predicted bounding boxes for the undetected items are merged at 1314. The process terminates thereafter.

While the operations illustrated in FIG. 13 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 13.

FIG. 14 is an exemplary flow chart illustrating operation of the computing device to update training data for use in retraining CV item detection models to detect previously undetected items. The process 1400 shown in FIG. 14 is performed by a customized returns manager component, executing on a computing device, such as the computing device 102 or the user device 116 in FIG. 1.

The process begins by obtaining data for one or more detected item(s) in a cart image at 1402. The detected items are masked by a first foundation model at 1404. A determination is made whether any items in the image are undetected at 1406. If not, the process terminates thereafter.

If there are undetected items in the masked cart image, the undetected items are identified at 1408. Labels are added to the undetected items at 1410. Predicted bounding boxes are generated for the undetected items at 1412. The predicted bounding boxes are merged with the detected item bounding boxes at 1414. The merged dataset is added to the training data at 1416. This creates an expanded set of items identified within the cart image. The process terminates thereafter.

While the operations illustrated in FIG. 14 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 14.

### Additional Examples

In some examples, to maintain the precision of a deep learning item detection model over time, the system persistently annotates (labels) fresh item image data and incorporates the annotated image data (labeled image data) into the training dataset for periodic model retraining. One hurdle in this process is selecting the most valuable data from a pool of unlabeled image data including thousands or even tens of thousands of shopping cart images, in order to not only boost the model's performance during training but also to manage the expenditure of time and resources involved in data annotation. Thankfully, the use of large pre-trained models (SAM) allows automation of the filtering process, efficiently pinpointing the unlabeled data that is most advantageous during the model's retraining phase.

Based on a current pretrained item detection model, the system obtains bounding box data for one or more detected items in the cart images. The system blacks out the detected items. The system segments the image to identify the undetected items using graphics algorithms to find the undetected items in the cart image.

In an example scenario, a first foundation model obtains bounding box data for a set of detected items from a current item detection model. The first foundation model (model A) blacks out the detected items from the image. In some embodiments, the first foundation model is a transformer model. A second foundation model (model B) filters out the masked items and generates labels (captions) for the undetected items. In some embodiments, the second foundation model is implemented as a large language model, such as a virtual question answering (VQA) model or another generative language model. The second foundation model answers the question “what is the item in the image,” by combining the image with text. A third foundation model (model C) predicts the bounding box for each undetected item. The third foundation model merges the bounding box data for the detected items and the undetected items. This merged dataset is an expanded set of items identified within the cart image. The merged dataset is used to retrain the detection model.

Manually generating training data by human users is a slow, tedious, and time-consuming process which generates less training data than can be created using an automated pipeline for generating labeled training images. The labeled training data generated using the foundation models enables faster and more efficient generation of training data which can be used to train item detection models more quickly than is possible with manually generated data. For example, training models using twenty thousand labeled images can take three weeks or more while training the same models using the undetected item manager to create sixty to seventy thousand labeled images for training data with a training time of only one or two days. In this manner, models can be trained more accurately, effectively, and quickly.

Foundation models, in some examples, are trained using a large variety of data sets with millions of labeled images. The models provide general information that can describe the items in each image, such as with labels (captions/annotations). With the help of the foundation model, the system can leverage this capability and label data.

Given raw images, a trained item detection model is applied to identify items in an image. The detected items are masked with a black mask to filter out the items that are handled correctly and detected. Given this masked image, a first foundation model is applied to see if any other items in the cart image are undetected. Given this image, the foundation model returns captions/annotations identifying items, such as a bottle, a human hand, dog, etc. Another foundation model is applied to find the missing items. A third foundation model generates a bounding box around each undetected item and merges the bounding boxes with the previously detected items. In some embodiments, the third foundation model is implemented as a CNN model to predict the bounding boxes for each undetected item. Given this raw image and final merged bounding boxes, the system is used to retrain the item detection model into a better version capable of detecting more items. The foundation models permit a greater variety of input and output into the models. The foundation models are trained on a large amount of unlabeled data. They are known for their adaptability and slow processing times.

Alternatively, or in addition to the other examples described herein, examples include any combination of the following:
a first foundation model that generates masked image data corresponding to the cart image, the masked image data comprising the cart image including at least one masked item in the cart image and at least one unmasked item in the cart image;
a second foundation model that refines item captions for each undetected item in the second set of items remaining unmasked;
a third foundation model that generates a predicted bounding box around each undetected item remaining unmasked in the cart image;
retrain the CV item detection model using training data including the merged set of identified items thereby improving item detection by the CV item detection model to include both the first set of items and the second set of items;
obtain an image comprising a shopping cart and a plurality of items within the shopping cart;
generate, by a CV cart detection model, the cart image, the cart image comprising the shopping cart and the plurality of items;
generate, by the CV item detection model, a bounding box around each detected item in the plurality of items;
mask each item in the plurality of items enclosed by the bounding box generated by the CV item detection model, wherein undetected items unenclosed by any bounding box remain unmasked;
obtain, from a plurality of image capture devices, image data comprising a plurality of cart images;
identify items in each cart image in the plurality of cart images by the CV item detection model;
identify undetected items in each cart image in the plurality of images which remain undetected by the CV item detection model;
analyze the undetected items in each cart image to predict bounding boxes corresponding to each undetected item and a label for each undetected item;
merge identified item data associated with identified items in each cart image with undetected item data associated with the undetected items in each cart image, the undetected item data comprising predicted bounding boxes and predicted labels for the undetected items;
generate updated training data including the merged set of identified items periodically using unlabeled image data obtained from a pool of unlabeled image data, wherein the CV item detection model is continuously retrained to improve detection of items within the retail facility;
perform segmentation on the cart image, by a pretrained segmentation model, to find undetected items in the masked image data;
detecting, by a computer vision (CV) item detection model, a first set of items in a cart image generated by an image capture device associated with a retail facility, each item in the set of detected items associated with a bounding box in a first set of bounding boxes;
masking the first set of items in the cart image by a first foundation model;
identifying, by a second foundation model, a second set of items in the cart image remaining undetected by the CV item detection model, wherein the second set of items are unmasked;
adding a set of labels to the second set of items, wherein each item in the second set of items includes a text label identifying the undetected item from the cart image;
generating a second set of bounding boxes associated with the second set of items, wherein each undetected item in the second set of items is enclosed within a predicted bounding box in the second set of bounding boxes;
merging the first set of bounding boxes associated with the first set of items and the second set of bounding boxes associated with the second set of items into a merged set of identified items associated with the cart image;
adding the merged set of identified items to a set of training data, wherein the training data is used to retrain the CV item detection model to identify both the first set of items and the second set of items in image data;
generating, by a first foundation model, masked image data corresponding to the cart image, the masked image data comprising the cart image including at least one masked item in the cart image and at least one unmasked item in the cart image;
refining, by a second foundation model, an item caption corresponding to each undetected item in the second set of items remaining unmasked;
generating, by a third foundation model, a predicted bounding box around each undetected item remaining unmasked in the cart image;
retraining the CV item detection model using training data including the merged set of identified items thereby improving item detection by the CV item detection model to include both the first set of items and the second set of items;
obtaining an image comprising a shopping cart and a plurality of items within the shopping cart;
generating, by a CV cart detection model, the cart image, the cart image comprising the shopping cart and the plurality of items;
generating, by the CV item detection model, a bounding box around each detected item in the plurality of items;
masking each item in the plurality of items enclosed by the bounding box generated by the CV item detection model, wherein undetected items unenclosed by any bounding box remain unmasked;
obtaining image data comprising a plurality of cart images;
identifying items in each cart image in the plurality of cart images by the CV item detection model;
identifying undetected items in each cart image in the plurality of images which remain undetected by the CV item detection model;
analyzing the undetected items in each cart image to predict bounding boxes corresponding to each undetected item and a label for each undetected item;
merging identified item data associated with identified items in each cart image with undetected item data associated with the undetected items in each cart image, the undetected item data comprising predicted bounding boxes and predicted labels for the undetected items;
performing segmentation on the cart image, by a pretrained segmentation model, to find undetected items in the masked image data;
generating updated training data including the merged set of identified items periodically using unlabeled image data obtained from a pool of unlabeled image data, wherein the CV item detection model is continuously retrained to improve detection of items within the retail facility;
masking a plurality of detected items in the cart image;
refining a plurality of initial item captions corresponding to a plurality of unmasked items in the cart image into a plurality of refined item captions identifying each undetected item remaining unmasked in the cart image;
generating a plurality of predicted bounding boxes around each undetected item remaining unmasked in the cart image;
retrain the CV item detection model using training data including the merged set of identified items to improve accuracy of item detection by the CV item detection model;
obtain an image comprising a shopping cart and a plurality of items within the shopping cart;
crop the image, by a CV cart detection model, to generate the cart image, the cart image comprising the shopping cart and the plurality of items;
generate, by the CV item detection model, a bounding box around each detected item in the plurality of items, wherein each item in the plurality of items enclosed by the bounding box generated by the CV item detection model is masked, and wherein undetected items unenclosed by any bounding box remain unmasked;
obtain image data from at least one image capture device, the raw image data comprising a plurality of cart images;
identify a plurality of items in each cart image in the plurality of cart images by the CV item detection model;
identify a plurality of undetected items in each cart image in the plurality of images which remain undetected by the CV item detection model;
analyze the plurality of undetected items in each cart image to predict bounding boxes corresponding to each undetected item and a label for each undetected item;
merge identified item data associated with the plurality of identified items in each cart image with undetected item data associated with the plurality of undetected items in each cart image, the undetected item data comprising predicted bounding boxes and predicted labels for the undetected items; and
performing image segmentation, by a pretrained segmentation model, to locate at least one undetected item in the masked image data.

At least a portion of the functionality of the various elements in FIG. 1, FIG. 2, FIG. 3, and FIG. 4 can be performed by other elements in FIG. 1, FIG. 2, FIG. 3, and FIG. 4, or an entity (e.g., processor 106, web service, server, application program, computing device, etc.) not shown in FIG. 1, FIG. 2, FIG. 3, and FIG. 4.

In some examples, the operations illustrated in FIG. 12, FIG. 13, and FIG. 14 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of identifying missed item detections in image data using foundation models, the method comprising detecting, by a computer vision (CV) item detection model, a first set of items in a cart image generated by an image capture device associated with a retail facility, each item in the set of detected items associated with a bounding box in a first set of bounding boxes; masking the first set of items in the cart image by a first foundation model; identifying, by a second foundation model, a second set of items in the cart image remaining undetected by the CV item detection model, wherein the second set of items are unmasked; adding a set of labels to the second set of items, wherein each item in the second set of items includes a text label identifying the undetected item from the cart image; generating a second set of bounding boxes associated with the second set of items, wherein each undetected item in the second set of items is enclosed within a predicted bounding box in the second set of bounding boxes; merging the first set of bounding boxes associated with the first set of items and the second set of bounding boxes associated with the second set of items into a merged set of identified items associated with the cart image; and adding the merged set of identified items to a set of training data, wherein the training data is used to retrain the CV item detection model to identify both the first set of items and the second set of items in image data.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for identifying missed item detections in image data using foundation models. For example, the elements illustrated in FIG. 1, FIG. 2, FIG. 3, and FIG. 4, such as when encoded to perform the operations illustrated in FIG. 12, FIG. 13, and FIG. 14, constitute exemplary means for detecting, by a computer vision (CV) item detection model, a first set of items in a cart image generated by an image capture device associated with a retail facility, each item in the set of detected items associated with a bounding box in a first set of bounding boxes; exemplary means for masking the first set of items in the cart image by a first foundation model; exemplary means for identifying, by a second foundation model, a second set of items in the cart image remaining undetected by the CV item detection model, wherein the second set of items are unmasked; exemplary means for adding a set of labels to the second set of items, wherein each item in the second set of items includes a text label identifying the undetected item from the cart image; exemplary means for generating a second set of bounding boxes associated with the second set of items, wherein each undetected item in the second set of items is enclosed within a predicted bounding box in the second set of bounding boxes; exemplary means for merging the first set of bounding boxes associated with the first set of items and the second set of bounding boxes associated with the second set of items into a merged set of identified items associated with the cart image; and exemplary means for adding the merged set of identified items to a set of training data, wherein the training data is used to retrain the CV item detection model to identify both the first set of items and the second set of items in image data.

Other non-limiting examples provide one or more computer storage devices having a first computer-executable instructions stored thereon for providing identification of missed item detections in image data using foundation models. When executed by a computer, the computer performs operations including detecting, by a computer vision (CV) item detection model, a first set of items in a cart image generated by an image capture device associated with a retail facility, each item in the set of detected items associated with a bounding box in a first set of bounding boxes; masking a first set of items associated with a cart image detected by a computer vision (CV) item detection model, the cart image generated by an image capture device associated with a retail facility, wherein each item in the first set of items is associated with a bounding box; identifying, by a second foundation model, a second set of items in the cart image remaining undetected by the CV item detection model, wherein the second set of items are unmasked; adding a set of labels to the second set of items, wherein each item in the second set of items includes a text label identifying the undetected item from the cart image; generating a second set of bounding boxes associated with the second set of items, wherein each undetected item in the second set of items is enclosed within a predicted bounding box in the second set of bounding boxes; and merging the first set of bounding boxes associated with the first set of items and the second set of bounding boxes associated with the second set of items into a merged dataset identifying the first set of items and the second set of items within the cart image, wherein the merged dataset of identified items are used to retrain the CV item detection model to enable the CV item detection model to identify items in both the first set of items and the second set of items.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for identifying missed item detections in image data, the system comprising:
a processor; and
a computer-readable medium storing instructions that are operative upon execution by the processor to:
detect, by a computer vision item detection model, a first set of items in a cart image generated by an image capture device associated with a retail facility, each item in the first set of items associated with a bounding box in a first set of bounding boxes;
mask the first set of items associated with the cart image;
identify a second set of items in the cart image remaining undetected by the computer vision item detection model, wherein the second set of items are unmasked;
add a set of labels to the second set of items, the set of labels comprising a text label identifying each undetected item from the cart image;
generate a second set of bounding boxes associated with the second set of items, each bounding box in the second set of bounding boxes enclosing each undetected item in the second set of items; and
merge the first set of bounding boxes associated with the first set of items and the second set of bounding boxes associated with the second set of items to create a merged dataset identifying the first set of items and the second set of items within the cart image, wherein the merged dataset of identified items are used to retrain the computer vision item detection model to identify items in both the first set of items and the second set of items.

2. The system of claim 1, wherein the instructions are further operative to:
a first foundation model that generates masked image data corresponding to the cart image, the masked image data comprising the cart image including at least one masked item in the cart image and at least one unmasked item in the cart image;
a second foundation model that refines item captions for each undetected item in the second set of items remaining unmasked; and
a third foundation model that generates a predicted bounding box around each undetected item remaining unmasked in the cart image.

3. The system of claim 1, wherein the instructions are further operative to:
retrain the computer vision item detection model using training data including the merged dataset to improve item detection by the computer vision item detection model.

4. The system of claim 1, wherein the instructions are further operative to:
obtain an image comprising a shopping cart and a plurality of items within the shopping cart;
generate, by the computer vision item detection model, at least one bounding box around each detected item in the plurality of items; and
mask detected items enclosed by bounding boxes, wherein undetected items unenclosed by any bounding box remain unmasked.

5. The system of claim 1, wherein the instructions are further operative to:
obtain a plurality of images generated by a plurality of image capture devices;
identify undetected items in each cart image in the plurality of images which remain undetected by the computer vision item detection model;
analyze the undetected items in each cart image to predict bounding boxes corresponding to each undetected item and a label for each undetected item; and
merge identified item data associated with identified items in each cart image with undetected item data associated with the undetected items in each cart image, the undetected item data comprising predicted bounding boxes and predicted labels for the undetected items.

6. The system of claim 1, wherein the instructions are further operative to:
generate updated training data periodically using unlabeled image data obtained from a pool of unlabeled image data, wherein the computer vision item detection model is continuously retrained to improve detection of items within the retail facility.

7. The system of claim 1, wherein the instructions are further operative to:
perform segmentation on the cart image, by a pretrained segmentation model, to find undetected items in masked image data.

8. A method for identifying missed item detections in image data using foundation models, the method comprising:
detecting, by a computer vision item detection model, a first set of items in a cart image generated by an image capture device, each item in the first set of items associated with a bounding box in a first set of bounding boxes;
masking the first set of items in the cart image by a first foundation model;
identifying, by a second foundation model, a second set of items in the cart image remaining undetected by the computer vision item detection model, wherein the second set of items are unmasked;
adding a set of labels to the second set of items, wherein each item in the second set of items includes a text label identifying an undetected item from the cart image;
generating a second set of bounding boxes associated with the second set of items, wherein each undetected item in the second set of items is enclosed within a predicted bounding box in the second set of bounding boxes;
merging the first set of bounding boxes associated with the first set of items and the second set of bounding boxes associated with the second set of items into a merged set of identified items associated with the cart image; and
adding the merged set of identified items to training data, wherein the training data is used to retrain the computer vision item detection model to identify both the first set of items and the second set of items in images.

9. The method of claim 8, further comprising:
generating, by the first foundation model, masked image data corresponding to the cart image, the masked image data comprising the cart image including at least one masked item in the cart image and at least one unmasked item in the cart image;
refining, by the second foundation model, an item caption corresponding to each undetected item in the second set of items remaining unmasked; and
generating, by a third foundation model, at least one bounding box around each undetected item remaining unmasked in the cart image.

10. The method of claim 8, further comprising:
retraining the computer vision item detection model using training data including the merged set of identified items thereby improving item detection by the computer vision item detection model to include both the first set of items and the second set of items.

11. The method of claim 8, further comprising:
obtaining an image comprising a shopping cart and a plurality of items within the shopping cart;
generating, by the computer vision item detection model, at least one bounding box around each detected item within the image; and
masking each detected item enclosed by the at least one bounding box, wherein undetected items unenclosed by any bounding box remain unmasked.

12. The method of claim 8, further comprising:
obtaining a plurality of images generated by at least one image capture device;
identifying items in each cart image in the plurality of images by the computer vision item detection model;
identifying undetected items in each cart image in the plurality of images which remain undetected by the computer vision item detection model;
analyzing the undetected items in each cart image to predict bounding boxes corresponding to each undetected item and a label for each undetected item; and
merging identified item data associated with identified items in each cart image with undetected item data associated with the undetected items in each cart image, the undetected item data comprising predicted bounding boxes and predicted labels for the undetected items.

13. The method of claim 8, further comprising:
performing segmentation on the cart image, by a pretrained segmentation model, to find undetected items in masked image data having at least one masked item.

14. The method of claim 8, further comprising:
generating updated training data including the merged set of identified items periodically using unlabeled image data obtained from a pool of the unlabeled image data, wherein the computer vision item detection model is continuously retrained to improve detection of items within images.

15. One or more computer storage devices having computer-executable instructions stored thereon, which, upon execution by a computer, cause the computer to perform operations comprising:
detecting, by a computer vision item detection model, a first set of items in a cart image generated by an image capture device associated with a retail facility, each item in the first set of items associated with a bounding box in a first set of bounding boxes;
masking the first set of items in the cart image by a first foundation model;
identifying, by a second foundation model, a second set of items in the cart image remaining undetected by the computer vision item detection model, wherein the second set of items are unmasked;
adding a set of labels to the second set of items, wherein each item in the second set of items includes a text label identifying each undetected item in the cart image;
generating a second set of bounding boxes associated with the second set of items, wherein each undetected item in the second set of items is enclosed within a predicted bounding box in the second set of bounding boxes;
merging the first set of bounding boxes associated with the first set of items and the second set of bounding boxes associated with the second set of items into an expanded set of items identified within the cart image; and
adding the expanded set of items to a set of training data, wherein the set of training data is used to retrain the computer vision item detection model to identify both the first set of items and the second set of items in image data.

16. The one or more computer storage devices of claim 15, wherein the operations further comprise:
masking a plurality of detected items in the cart image;
refining a plurality of initial item captions corresponding to a plurality of unmasked items in the cart image into a plurality of refined item captions identifying each undetected item remaining unmasked in the cart image; and
generating a plurality of predicted bounding boxes around each undetected item remaining unmasked in the cart image.

17. The one or more computer storage devices of claim 15, wherein the operations further comprise:
retrain the computer vision item detection model periodically using updated training data to improve accuracy of item detection by the computer vision item detection model.

18. The one or more computer storage devices of claim 15, wherein the operations further comprise:
obtain an image comprising a shopping cart and a plurality of items within the shopping cart;
crop the image, by a computer vision cart detection model, to generate the cart image, the cart image comprising the shopping cart and the plurality of items; and
generate, by the computer vision item detection model, at least one bounding box around each detected item in the plurality of items, wherein detected items enclosed by bounding boxes are masked, and wherein undetected items unenclosed by any bounding box remain unmasked.

19. The one or more computer storage devices of claim 15, wherein the operations further comprise:
obtain a plurality of images from at least one image capture device;
identify a plurality of items in each image in the plurality of images by the computer vision item detection model;
identify a plurality of undetected items in each cart image in the plurality of images which remain undetected by the computer vision item detection model;
analyze the plurality of undetected items in each cart image to predict bounding boxes corresponding to each undetected item and a label for each undetected item; and
merge identified item data with undetected item data associated with the plurality of undetected items in each cart image, the undetected item data comprising predicted bounding boxes and predicted labels for undetected items.

20. The one or more computer storage devices of claim 15, wherein the operations further comprise:
performing image segmentation, by a pretrained segmentation model, to locate at least one undetected item in masked image data.
